(19) United States
(12) Patent Application Publication
(10) Pub. No.: US 2025/0336269 A1
(43) Pub. Date: Oct. 30, 2025

(54) MIXED-PROTOCOL PROGRESSIVE CONTROLLER FOR A PROGRESSIVE WAGERING GAME

(71) Applicant: IGT, Las Vegas, NV (US)

(72) Inventors: Dwayne NELSON, Las Vegas, NV (US); Kevin HIGGINS, Reno, NV (US)

(73) Assignee: IGT, Las Vegas, NV (US)

(21) Appl. No.: 18/644,226

(22) Filed: Apr. 24, 2024

(51) Int. Cl. G07F 17/32

(52) U.S. Cl. CPC G07F 17/3258

(57) ABSTRACT

A progressive controller determines that a gaming device has triggered a progressive win for a progressive wagering game. The controller determines whether the first gaming device is in a first subset of gaming devices having a first communication protocol compatibility. In response to a determination that the first gaming device is not in the first subset of gaming devices, the controller determines whether the first gaming device is in a second subset of gaming devices having a second communication protocol compatibility. In response to a determination that the gaming device is in the first subset, the gaming device awards a first progressive prize corresponding to the progressive win. In response to a determination that the gaming device is in the second subset and that the gaming device is not in the first subset, the gaming device awards a second progressive prize corresponding to the progressive win.

### BACKGROUND

Embodiments described herein relate to progressive controllers, and in particular to a mixed-protocol progressive controller for a progressive wagering game, and related devices, systems, and methods. Some wagering games, such as slot-style games provided at Electronic Gaming Machines (EGMs) and/or other gaming devices in a casino or other environment may provide access to a progressive wagering game that allows multiple gaming devices to contribute to and win from a large progressive prize pool. Different communications protocols used by the gaming devices to communicate with a progressive controller managing the progressive wagering game may support different feature sets and may have different communication capabilities. There is a need for a progressive controller that is capable of managing a single progressive wagering game for different gaming devices having different capabilities.

### BRIEF SUMMARY

According to some embodiments, a system includes a processor circuit and a memory coupled to the processor circuit. The memory includes machine-readable instructions that, when executed by the processor circuit, cause the processor circuit to determine that a first gaming device of a plurality of gaming device has triggered a progressive win for a progressive wagering game. The instructions further cause the processor circuit to determine a communication protocol capability of the first gaming device. The instructions further cause the processor circuit to, in response to the determined communication protocol capability of the first gaming device indicating compatibility with a first communication protocol of a plurality of communication protocols, cause the first gaming device to award a first progressive prize corresponding to the progressive win. The instructions further cause the processor circuit to, in response to the determined communication protocol capability of the first gaming device indicating incompatibility with a first communication protocol and compatibility with a second communication protocol of a plurality of communication protocols. determine a second progressive prize based on the first progressive prize, and cause the first gaming device to award the second progressive prize.

According to some embodiments, a progressive controller includes a communication interface in communication with a plurality of gaming devices comprising a first subset of gaming devices comprising a first communication protocol compatibility and a second subset of gaming devices comprising a second communication protocol compatibility, a processor circuit, and a memory coupled to the processor circuit. The memory includes machine-readable instructions that, when executed by the processor circuit, cause the processor circuit to determine that a first gaming device of the plurality of gaming devices has triggered a progressive win for a progressive wagering game. The instructions further cause the processor circuit to determine whether the first gaming device is in the first subset of gaming devices. The instructions further cause the processor circuit to, in response to a determination that the first gaming device is not in the first subset of gaming devices, determine whether the first gaming device is in the second subset of gaming devices. The instructions further cause the processor circuit to, in response to a determination that the first gaming device is in the first subset of gaming devices, cause the first gaming device to award a first progressive prize corresponding to the progressive win. The instructions further cause the processor circuit to, in response to a determination that the first gaming device is in the second subset of gaming devices and that the first gaming device is not in the second subset of gaming devices, cause the first gaming device to award a second progressive prize corresponding to the progressive win.

According to some embodiments, a method includes determining, by a processor circuit of a progressive controller, that a first gaming device of a plurality of gaming devices in communication with the progressive controller has triggered a progressive win for a progressive wagering game, the plurality of gaming devices comprising a first subset of gaming devices comprising a first communication protocol compatibility and a second subset of gaming devices comprising a second communication protocol compatibility. The method further includes determining, by the processor circuit, whether the first gaming device is in the first subset of gaming devices. The method further includes, in response to a determination that the first gaming device is not in the first subset of gaming devices, determining, by the processor circuit, whether the first gaming device is in the second subset of gaming devices. The method further includes, in response to a determination that the first gaming device is in the first subset of gaming devices, causing, by the processor circuit, the first gaming device to award a first progressive prize corresponding to the progressive win. The method further includes, in response to a determination that the first gaming device is in the second subset of gaming devices and that the first gaming device is not in the first subset of gaming devices, causing, by the processor circuit, the first gaming device to award a second progressive prize corresponding to the progressive win.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 illustrates a system including a multi-protocol progressive controller managing a progressive wagering game for different EGMs having different protocols and capabilities, according to some embodiments.

FIGS. 4A and 4B are communication diagrams illustrating operations of the controller and gaming devices of FIG. 3, according to some embodiments.

FIG. 5 is a flowchart illustrating operations of systems/methods of managing a progressive wagering game for different EGMs using different protocols, according to some embodiments.

### DETAILED DESCRIPTION

Embodiments described herein relate to progressive controllers, and in particular to a mixed-protocol progressive controller for a progressive wagering game, and related devices, systems, and methods.

One challenge with providing progressive wagering games is that different gaming devices may support different communications protocols, which may in turn support and enable more advanced progressive game features for certain protocols. For example, some standards for a host to communicate with an EGM, such as the Slot Accounting System (SAS) protocol, were created years ago and support most EGMs currently in use, but support limited features for progressive games and may not support many advanced features available on newer protocols, such as the Ethernet IGT Progressive Protocol (eIPP) protocol, such as non-monetary progressive levels and/or awards. This excludes older EGMs, as well as many EGMs produced by other manufacturers, from participating in progressive games having these more advanced features. Embodiments disclosed herein provide a unique technical solution to these and other technical problems.

In some examples, a progressive controller can support multiple protocols, such as SAS and eIPP, for the same progressive game, including standalone progressives (i.e., where the progressive levels are managed at the EGM level), bank-level progressives, and/or wide-area progressives. Many progressive games may display a current progressive level amount (e.g., a monetary jackpot amount and/or non-monetary prize), on signs or on the EGM displays. The progressive controller can provide and manage multiple levels, and when games are played, a portion of each wager may be added to one or more levels.

In a conventional SAS-based progressive game, a plurality of EGMs may be connected to a controller in a “multi drop” configuration (i.e., with all of the EGMs on a common serial loop), and/or using multiple serial and/or optical ports. The operator configures the progressive levels, such as level reset values, contribution percentages, etc., on the progressive controller and configures game(s) on the EGMs to link the games to those levels (e.g., for certain game themes, paytables, denominations, etc.). This manual process may be susceptible to human error, and also may require paperwork to change or remove a progressive prize pool from the controller

In some embodiments of the disclosure, however, a progressive game may use more modern protocols, such as eIPP, which may allow for a host system to configure and manage both the progressive controller and the EGMs remotely, with less effort and with less error. Meanwhile, legacy and/or competitor EGMs can still be connected to the same progressive controller using SAS or another older protocol. This configuration allows all EGMs to contribute to the same progressive levels. For new features that are only supported on the more advanced protocol, the progressive controller can provide awards to modern EGMs normally and may map awards based on these features to more conventional monetary awards for the legacy and/or competitor EGMs.

For example, some progressive games employ non-monetary progressive levels, such as an incrementing unitless number, as opposed to a monetary amount. The awards for these progressive games may be provided as non-monetary awards based on the progressive level, such as a number of free spins, a multiplier, etc. However, if a legacy and/or competitor EGM using an older protocol wins the progressive, the progressive controller maps the progressive level to a monetary value and notifies the legacy and/or competitor EGM using the older protocol. In some examples, the progressive controller may also cause the legacy and/or competitor EGM to display a message, e.g., via a service window, that other EGMs may be capable of more exciting types of progressive awards, such as free spins or multipliers, rather than a set monetary award, thereby encouraging players of legacy and/or competitor EGMs to play on newer EGMs that are compatible with the newer protocols. In some examples, the progressive “hit” may be determined by an EGM being played, or may be determined by the progressive controller or other host (a.k.a., “mystery progressive”).

In some examples, the progressive controller can determine separate progressive level values for each contribution, e.g., adding a monetary value to a legacy progressive level and a non-monetary value to a modern progressive level, with one or both level values being displayed on a standalone and/or EGM display. For example, an EGM wager of $1.00 at a newer EGM may contribute 0.05 points to level 1 of the progressive, while an older EGM may contribute $0.05. The controller may determine that level 1 is now 11.55 points and $119.20 dollars. In the event of a progressive win by a newer EGM, the controller may send 11.55 points to the EGM, or in the event of a win by an older EGM, the controller may send $119.20 to the EGM. In some embodiments, one or both amounts may also be provided to different signs or displays based on protocols being used and/or the protocols of associated EGMs. For example, a bank-level sign for EGMs using a legacy protocol may display the monetary level value, while a bank-level sign for EGMs using a newer protocol may display the non-monetary level value, and/or the signs may alternate between the different values.

In some examples, mapping the non-monetary progressive win to a legacy monetary value may be manually or automatically configured through the progressive controller. The mapping may include a proportional conversion rate, e.g., $1 per non-monetary point, or may be based on one or more EGM features, such as win capping. For example, in some markets, wins are capped or limited. If a player wins more than the cap on a legacy interface, such as SAS, capping may not be supported, or the EGM may be capable of capping a win but not reporting the capping to the controller. In some embodiments, legacy machines may be configured discard some amount of the progressive hit to comply with win capping requirements, while new IGT machines can honor the cap, return the excess money to the controller, and thereby allow the excess funds to be leveraged in the next jackpot.

In some examples, an event-based progressive, i.e., a progressive where the game contributes to the progressive controller for any event and can even contribute multiple times per game cycle, may include may tracking events that are generated at the start of the game, such as traditional progressive events which are considered progressive wins, as well as other events, which are paytable related, such as hitting the bonus, and which are considered paytable wins. A controller can track the two pools separately using eIPP or other advanced protocols, but cannot using legacy protocols such as SAS. In some examples, when the legacy EGM wins an event based progressive, the controller may award the progressive part of the progressive via SAS and may award the remaining paytable portion of the progressive using another method, such as AFT, EFT or SAS bonusing features (e.g., paid as a machine won external bonus, which is taxed as traditional paytable win). In some examples, mapping and awarding SAS prizes may not be practical, in which case the legacy protocol may not act as a progressive host for legacy EGMs. When a win occurs, the host may determine that the legacy EGM cannot understand the event and may instead transfer money to the legacy EGM using SAS AFT, EFT or legacy bonusing. In this example, the controller may transfer money to the EGM rather than award a progressive on the EGM, but this may result in different tax and/or regulatory treatment of certain transfers and/or wins in some jurisdictions.

In some examples, auditing the contributions from different EGMs for a progressive prize pool may pose difficulties. For example, in a traditional progressive prize pool, the current pool value can be audited by looking at a reset value of the progressive plus any overflow amounts from the previous progressive, taking the initial meter value of contributing EGMs and comparing that to the snapshotted meter value from those same contributing EGMs when the progressive hit occurred, and deducting any new overflow amounts that occur (if the prize pool hit some configured limit), which should match the amount of the prize pool when a hit occurred. However, if a progressive supports event-based progressives, the current value cannot be audited.

In some examples using multiple protocols and features, a hybrid audit procedure may be used, where progressive contributions from legacy EGMs are calculated in a traditional manner, and that contribution amount is converted into the value that contributes to the progressive. In this example, the audit procedure can include communicating with contributing EGMs to determine the number of events that occurred over the period (e.g., via a meter, or reading a log entry exposed by each contributing new EGM). This value can then be combined with the value previously calculated from the legacy EGMs to determine if the progressive prize pool had the correct value (per the calculated number of events that occurred over the period). In some examples, this process could also be used to audit a current value of a prize pool, which may be useful if regulators are performing an audit of equipment (such as during the equipment regulatory submission or review process), or when performing an audit of a casino operator.

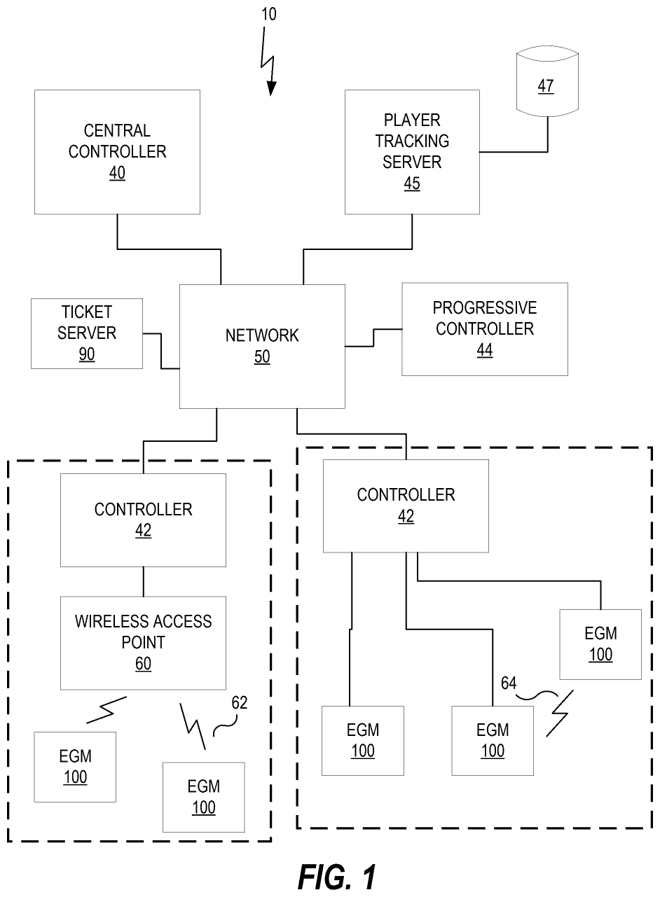

Before describing these and other features in greater detail, reference is now made to FIG. 1, which illustrates a gaming system 10 including a plurality of gaming devices 100 (which are EGMs in this embodiment). The gaming devices 100 may be one type of a variety of different types of gaming devices, such as electronic gaming machines (EGMs), video lottery terminals (VLTs), mobile gaming devices, or other devices, for example. The gaming system 10 may be located, for example, on the premises of a gaming establishment, such as a casino, and/or distributed across one or more different locations 15, such as a plurality of retailers or other establishments. The gaming devices 100 may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. Each location 15 may include a site controller 42 for managing communication with the central controller 40 and for controlling and managing the gaming devices 100. The central controller 40 and/or site controller 42 may be any suitable server or computing device which includes at least one processing circuit and at least one memory or storage device. Each gaming device 100 (which are EGMs in this example) may include a processing circuit that transmits and receives events, messages, commands or any other suitable data or signal between the gaming device 100, the site controller 42, and/or the central controller 40. The gaming device processing circuit is operable to execute such communicated events, messages or commands in conjunction with the operation of the gaming device 100. Moreover, the processing circuit of the and/or site controller 42 is configured to transmit and receive events, messages, commands or any other suitable data or signal between the central controller 40, the site controller 42, and/or each of the individual gaming devices 100. In some embodiments, one or more of the functions of the central controller 40 and/or site controller 42 may be performed by one or more gaming device processing circuits. Moreover, in some embodiments, one or more of the functions of one or more gaming device processing circuits as disclosed herein may be performed by the central controller 40 and/or site controller 42.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 and/or site controller 42 through the data communication network 50. The ticket server 90 may be located remotely from the individual locations 15 and/or site controllers 42 and/or may be located at individual locations 15 and/or proximate to individual site controllers 42. In some examples, the ticket server 90 and/or functions thereof may be integrated into the central controller 40 and/or local controllers 42. Each ticket server 90 may include a processing circuit that transmits and receives events, messages, commands or any other suitable data or signal between the ticket server 90 and the central controller 40 and/or local controller 42. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40 and/or local controller 42. In some embodiments, a progressive controller 44 may be in communication with the gaming devices 100 via one or more communication protocols, such as eIPP, SAS, etc., based on the communication capabilities of the respective gaming devices 100.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. Some embodiments provide that gaming devices 100 may communicate with other gaming devices 100 or other system components over a wireless interface 64. In these embodiments, wireless interface 62, and wireless interface 64 may use different communication protocols and/or different communication resources, such as different frequencies, time slots, spreading codes, etc.

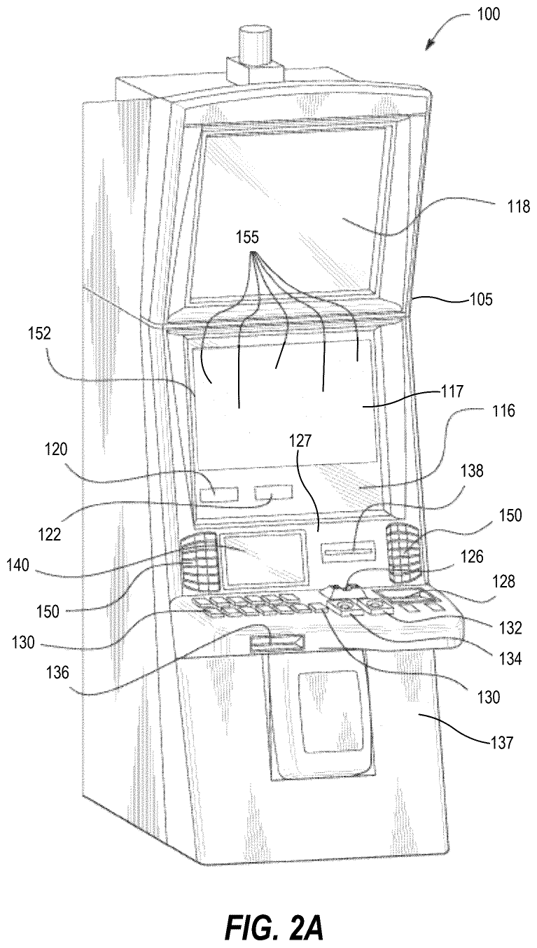

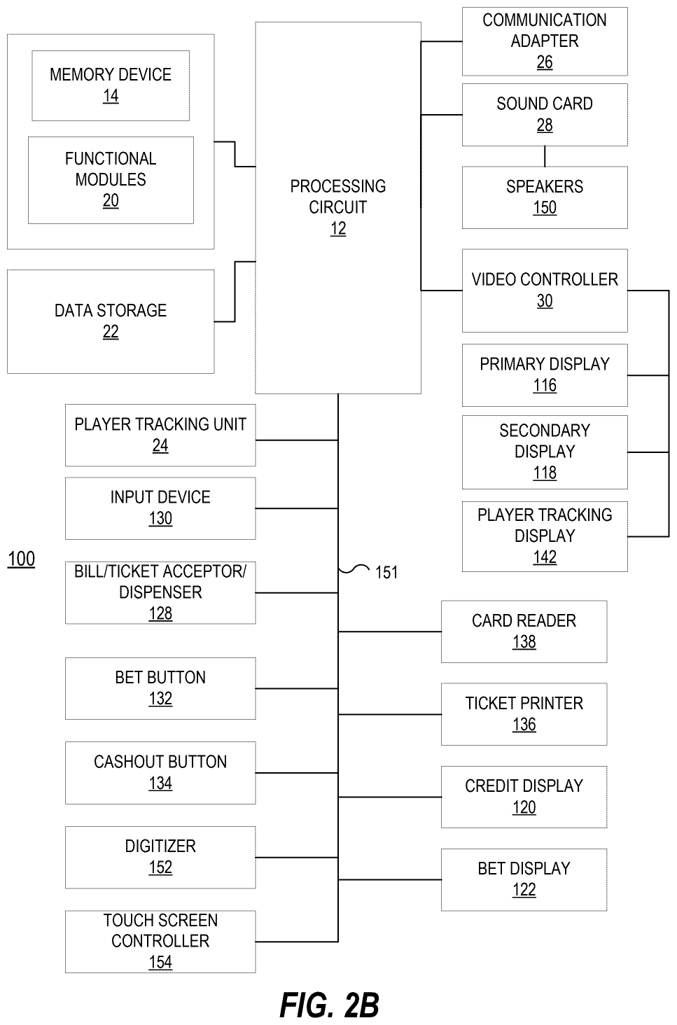

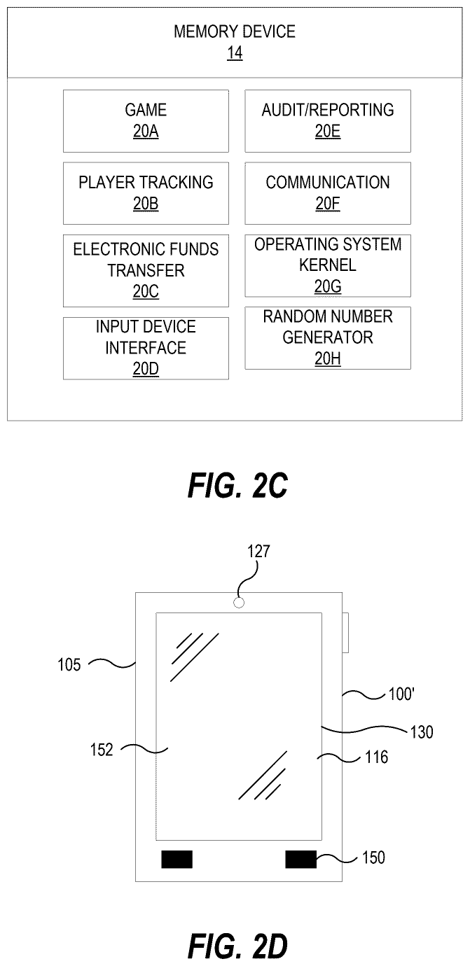

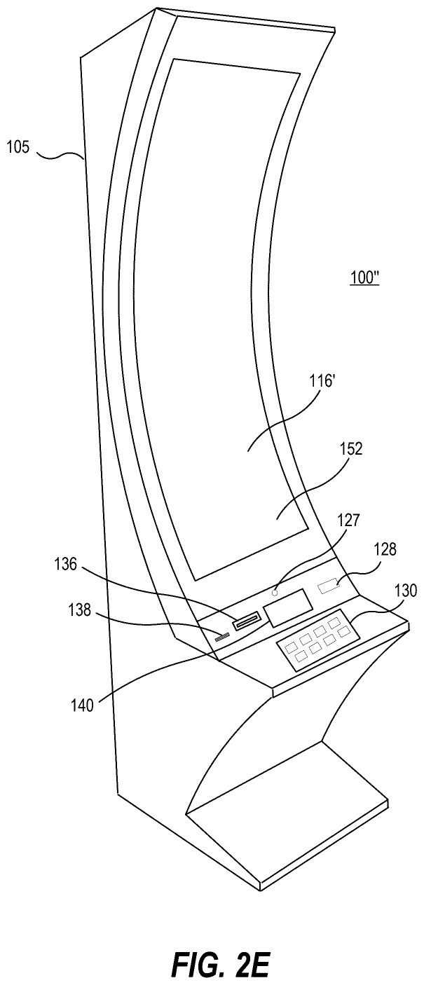

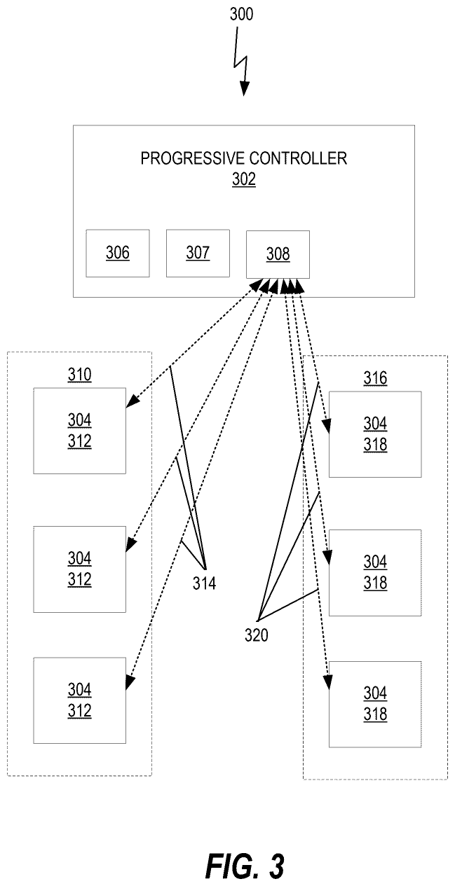

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as EGMs, VLTs, and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino, lottery, or other style games. Further, gaming devices according to embodiments herein may be implemented using other computing devices and mobile devices, such as smart phones, tablets, and/or personal computers, among others.

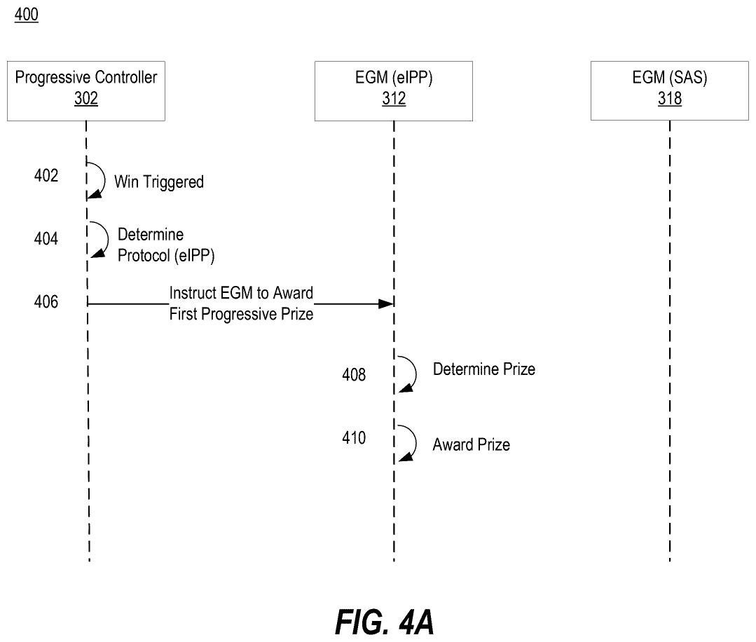

FIG. 3 illustrates a system 300 including a multi-protocol progressive controller 302 managing a progressive wagering game for a plurality of gaming devices 304 having different protocols and capabilities, according to some embodiments. In this example, the progressive controller 302 includes a processor circuit 306, a memory 307, and a communication interface 308 in communication with the plurality of gaming devices 304. The plurality of gaming devices 304 includes a first subset 310 of gaming devices 312 with a first communication protocol 314 compatibility (eIPP in this example) and a second subset 316 of gaming devices 318 with a second communication protocol 320 compatibility (SAS in this example). In this example, the gaming devices 312 in the first subset 310 may also have backward compatibility with the second communication protocol 320 (i.e., SAS) as well.

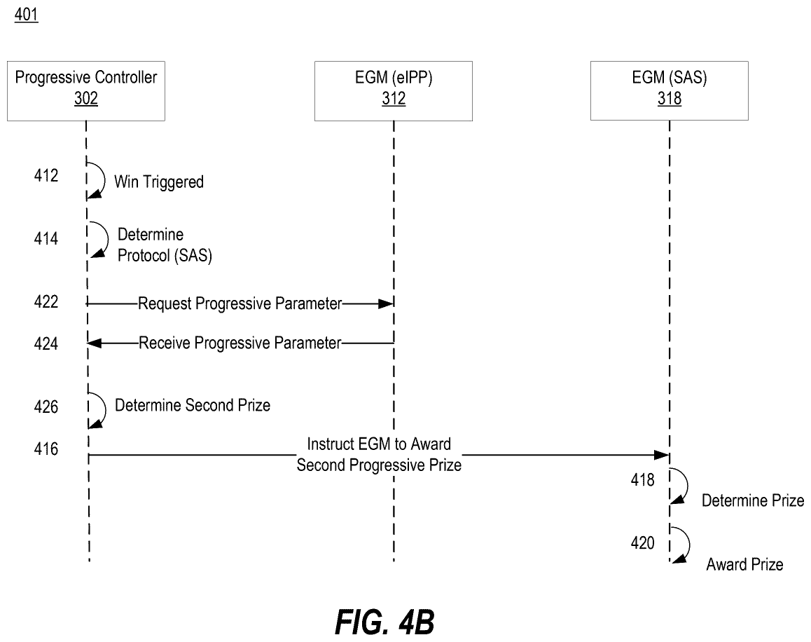

In this regard, FIGS. 4A and 4B are communication diagrams 400, 401 illustrating operations of the controller 302 and gaming devices 304 of FIG. 3, according to some embodiments. In the example of FIG. 4A, the controller 302 determines that a gaming device 312 (i.e., from the first subset 310 in FIG. 3) has triggered a progressive win for a progressive wagering game (operation 402). The controller 302 determines a communication protocol capability of the gaming device 312 (operation 404), which is the first communication protocol 314 (e.g., eIPP) in this example. Based on a determination of compatibility with the first communication protocol 314, the progressive controller 302 instructs the gaming device 312 to award a first progressive prize corresponding to the progressive win (operation 406). In response to the instruction, the gaming device 312 determines the first progressive prize (operation 408) and awards the first progressive prize (operation 410).

Referring now to FIG. 4B, the controller 302 may determine that another gaming device 318 (e.g., from the second subset 316 in FIG. 3) has triggered a progressive win for a progressive wagering game (operation 412). The controller 302 determines a communication protocol capability of the gaming device 318 (operation 414), which includes incompatibility with the first communication protocol 314 (e.g., eIPP) and compatibility with the second communication protocol 320 (e.g., SAS) in this example. Based on a determination of incompatibility with the first communication protocol 314 and compatibility with the second communication protocol 320, the progressive controller 302 instructs the gaming device 318 to award a second progressive prize based on the first progressive prize (operation 416). In response to the instruction, the gaming device 318 determines the second progressive prize based on the first progressive prize (operation 418) and awards the second progressive prize (operation 420).

In some examples, the gaming devices 312, 318 may provide progressive contribution amounts to the progressive controller 302 over time, with each progressive contribution amount increasing a value of a progressive level amount based on the progressive contribution amount. This progressive level amount value may be a unitless number rather than a monetary value, for example. In some examples, the award of the first progressive prize by the first gaming devices 312 may include transmission of a current progressive level amount value from the progressive controller 302 via the first communication protocol (e.g., eIPP) 314 to the first gaming device 312 and an instruction to the first gaming device 312 to determine the first progressive prize based on the current progressive level amount value. For example, the first progressive prize may include a plurality of free spins, a multiplier value for a plurality of spins, etc., corresponding to and/or based on the progressive level amount value.

However, for gaming devices 318 that are not compatible with eIPP and that instead use a legacy second communication protocol (e.g., SAS) 320, the progressive controller 302 may determine the second progressive prize based on the current progressive level amount value and a progressive prize parameter to determine an expected value for the first progressive prize. For example, the second progressive prize may include a monetary value corresponding to an expected win value of the plurality of free spins, or a monetary value corresponding to an expected win value for the plurality of spins times the multiplier value.

In the example of FIG. 4A, the progressive controller 302 may provide the current progressive level amount value to the eIPP-compatible gaming devices 312, and the gaming device 312 then selects the progressive prize parameter (e.g., free spins, multiplier, etc.) to determine and provide the first progressive prize. In the example of FIG. 4B, when a non-eIPP-compatible gaming device 318 is selected, the progressive controller may transmit a request for a progressive prize parameter to an eIPP-compatible gaming device 318 (operation 422), receive the progressive prize parameter from the gaming device 318 (operation 424), and determine an expected value of the first progressive prize based on the current progressive level amount value and the progressive prize parameter (operation 426). The second progressive prize is then determined based on the expected value of the first progressive prize (operation 428) and the instruction to award the second progressive prize is transmitted to the non-eIPP-compatible gaming device 318 via the second communication protocol (e.g., SAS) 320.

In some examples, providing the second progressive prize may include the progressive controller 302 transmitting a current progressive level amount value to the gaming device 318 via the second communication protocol 320 (e.g., SAS) and an instruction to the gaming device 318 to determine a value of the first progressive prize based on the current progressive level amount value, which is then determined and provided by the second gaming device 318.

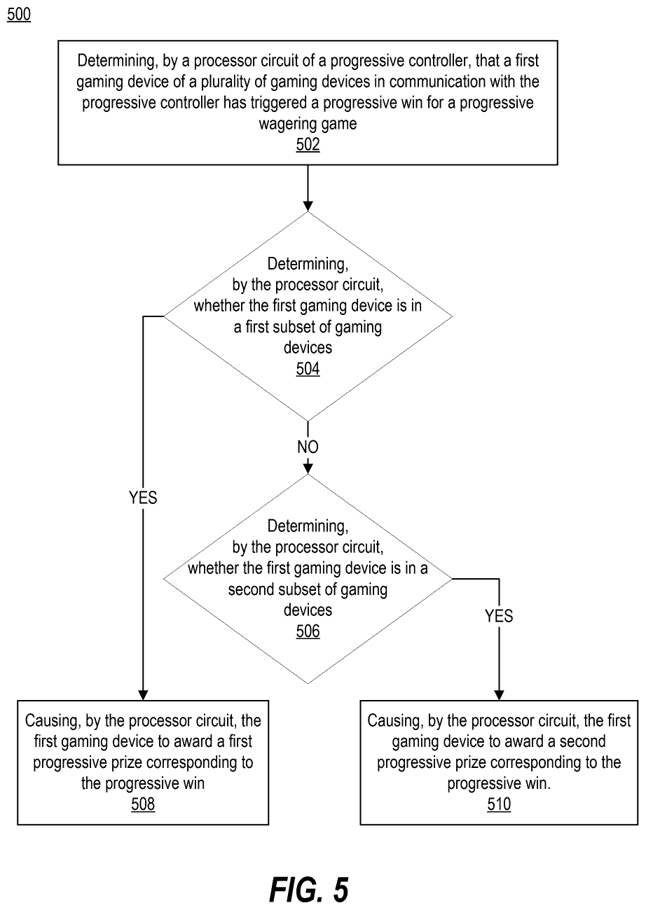

FIG. 5 is a flowchart illustrating operations 500 of operations of systems/methods, according to some embodiments. The operations 500 may include determining, by a processor circuit of a progressive controller, that a first gaming device of a plurality of gaming devices in communication with the progressive controller has triggered a progressive win for a progressive wagering game (Block 502). In this example, the plurality of gaming devices include a first subset of gaming devices comprising a first communication protocol compatibility (e.g., eIPP) and a second subset of gaming devices comprising a second communication protocol compatibility (e.g., SAS).

The operations 500 may further include determining, by the processor circuit, whether the first gaming device is in the first subset of gaming devices (Block 504). The operations 500 may further include, in response to a determination that the first gaming device is not in the second subset of gaming devices, determining, by the processor circuit, whether the first gaming device is in the second subset of gaming devices (Block 506). The operations 500 may further include, in response to a determination that the first gaming device is in the first subset of gaming devices, causing, by the processor circuit, the first gaming device to award a first progressive prize corresponding to the progressive win (Block 508). The operations 500 may further include, in response to a determination that the first gaming device is in the second subset of gaming devices and that the first gaming device is not in the first subset of gaming devices, causing, by the processor circuit, the first gaming device to award a second progressive prize corresponding to the progressive win (Block 510).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
determine that a first gaming device of a plurality of gaming device has triggered a progressive win for a progressive wagering game;
determine a communication protocol capability of the first gaming device;
in response to the determined communication protocol capability of the first gaming device indicating compatibility with a first communication protocol of a plurality of communication protocols, cause the first gaming device to award a first progressive prize corresponding to the progressive win; and
in response to the determined communication protocol capability of the first gaming device indicating incompatibility with a first communication protocol and compatibility with a second communication protocol of a plurality of communication protocols. determine a second progressive prize based on the first progressive prize, and cause the first gaming device to award the second progressive prize.

2. The system of claim 1, wherein the first communication protocol is Ethernet IGT Progressive Protocol (eIPP), and the second communication protocol is Slot Accounting System (SAS).

3. The system of claim 1, wherein the first progressive prize comprises a plurality of free spins, and wherein the second progressive prize comprises a monetary value corresponding to an expected win value of the plurality of free spins.

4. The system of claim 1, wherein the first progressive prize comprises a multiplier value for a plurality of spins, and wherein the second progressive prize comprises a monetary value corresponding to an expected win value for the plurality of spins times the multiplier value.

5. The system of claim 1, wherein the instructions further cause the processor circuit to:
receive plurality of progressive contribution amounts from the plurality of gaming devices; and
for each progressive contribution amount of the plurality of progressive contribution amounts, increase a value of a progressive level amount based on the progressive contribution amount.

6. The system of claim 5, wherein the award of the first progressive prize by the first gaming devices comprises:
transmission of a current progressive level amount value to the first gaming device and an instruction to the first gaming device to determine the first progressive prize based on the current progressive level amount value.

7. The system of claim 5, wherein the award of the second progressive prize by the first gaming device comprises:
transmission of a current progressive level amount value to a second gaming device of the plurality of gaming devices via the first communication protocol and an instruction to the second gaming device to determine a value of the first progressive prize based on the current progressive level amount value; and
determination of the second progressive prize based on the determined value of the first progressive prize.

8. The system of claim 5, wherein progressive level amount value is a unitless number.

9. The system of claim 5, wherein the award of the second progressive prize by the first gaming device comprises:
request for a progressive prize parameter from a second gaming device of the plurality of gaming devices via the first communication protocol; and
determination of the second progressive prize based on the requested progressive prize parameter and a current progressive level amount.

10. The system of claim 9, wherein the progressive prize parameter is a number of free spins, and
wherein the determined second progressive prize comprises a monetary value corresponding to an expected win value of a number of free spins equal to the current progressive level amount.

11. The system of claim 9, wherein the progressive prize parameter is a multiplier value for a plurality of spins, and
wherein the determined second progressive prize comprises a monetary value corresponding to an expected win value of the plurality of spins times the multiplier value.

12. A progressive controller comprising:
a communication interface in communication with a plurality of gaming devices comprising a first subset of gaming devices comprising a first communication protocol compatibility and a second subset of gaming devices comprising a second communication protocol compatibility;
a processor circuit; and
a memory coupled to the processor circuit, the memory comprising machine-readable instructions that, when executed by the processor circuit, cause the processor circuit to:
determine that a first gaming device of the plurality of gaming devices has triggered a progressive win for a progressive wagering game;
determine whether the first gaming device is in the first subset of gaming devices;
in response to a determination that the first gaming device is not in the first subset of gaming devices, determine whether the first gaming device is in the second subset of gaming devices;
in response to a determination that the first gaming device is in the first subset of gaming devices, cause the first gaming device to award a first progressive prize corresponding to the progressive win; and
in response to a determination that the first gaming device is in the second subset of gaming devices and that the first gaming device is not in the first subset of gaming devices, cause the first gaming device to award a second progressive prize corresponding to the progressive win.

13. The progressive controller of claim 12, wherein the first communication protocol is Ethernet IGT Progressive Protocol (eIPP), and the second communication protocol is Slot Accounting System (SAS).

14. The progressive controller of claim 12, wherein the first progressive prize comprises a plurality of free spins, and wherein the second progressive prize comprises a monetary value corresponding to an expected win value of the plurality of free spins.

15. The progressive controller of claim 12, wherein the first progressive prize comprises a multiplier value for a plurality of spins, and wherein the second progressive prize comprises a monetary value corresponding to an expected win value for the plurality of spins times the multiplier value.

16. The progressive controller of claim 12, wherein the instructions further cause the processor circuit to:
receive plurality of progressive contribution amounts from the plurality of gaming devices; and
for each progressive contribution amount of the plurality of progressive contribution amounts, increase a value of a progressive level amount based on the progressive contribution amount.

17. The progressive controller of claim 16, wherein the award of the first progressive prize by the first gaming devices comprises:
transmission of a current progressive level amount value to the first gaming device and an instruction to the first gaming device to determine the first progressive prize based on the current progressive level amount value.

18. The progressive controller of claim 16, wherein the award of the second progressive prize by the first gaming device comprises:
transmission of a current progressive level amount value to a second gaming device of the plurality of gaming devices via the second communication protocol and an instruction to the second gaming device to determine a value of the first progressive prize based on the current progressive level amount value; and
determination of the second progressive prize based on the determined value of the first progressive prize.

19. The progressive controller of claim 16, wherein the award of the second progressive prize by the first gaming device comprises:
request for a progressive prize parameter from a second gaming device of the plurality of gaming devices via the second communication protocol; and
determination of the second progressive prize based on the requested progressive prize parameter and a current progressive level amount.

20. A method comprising:
determining, by a processor circuit of a progressive controller, that a first gaming device of a plurality of gaming devices in communication with the progressive controller has triggered a progressive win for a progressive wagering game, the plurality of gaming devices comprising a first subset of gaming devices comprising a first communication protocol compatibility and a second subset of gaming devices comprising a second communication protocol compatibility;
determining, by the processor circuit, whether the first gaming device is in the first subset of gaming devices;
in response to a determination that the first gaming device is not in the first subset of gaming devices, determining, by the processor circuit, whether the first gaming device is in the second subset of gaming devices;
in response to a determination that the first gaming device is in the first subset of gaming devices, causing, by the processor circuit, the first gaming device to award a first progressive prize corresponding to the progressive win; and
in response to a determination that the first gaming device is in the second subset of gaming devices and that the first gaming device is not in the first subset of gaming devices, causing, by the processor circuit, the first gaming device to award a second progressive prize corresponding to the progressive win.
